(19) United States
(12) Patent Application Publication
(10) Pub. No.: US 2015/0161342 A1
(43) Pub. Date: Jun. 11, 2015

(54) INFORMATION PROCESSING SYSTEM, ELECTRONIC APPARATUS, METHOD AND STORAGE MEDIUM

(71) Applicant: KABUSHIKI KAISHA TOSHIBA, Tokyo (JP)

(72) Inventors: Junya TAKAKURA, Kawasaki (JP); Kanako Nakayama, Tokyo (JP); Sawa Fuke, Kawasaki (JP)

(21) Appl. No.: 14/548,960

(22) Filed: Nov. 20, 2014

(30) Foreign Application Priority Data
Dec. 10, 2013 (JP) 2013-255102

(51) Int. Cl. G06F 19/00; G06Q 10/10

(52) U.S. Cl. CPC G06F 19/3418; G06Q 10/1095

(57) ABSTRACT

According to one embodiment, an information processing system includes a biological sensor device to be worn by a patient and an electronic apparatus. The biological sensor device includes a measurement processor to continuously measure biological information of the patient. The electronic apparatus includes a first acquisition processor, a generator, a calculator and a scheduler. The scheduler schedules medical consultations for the patient based on a time when the patient visited a medical facility and a deviation.

### CROSS-REFERENCE TO RELATED APPLICATIONS

This application is based upon and claims the benefit of priority from Japanese Patent Application No. 2013-255102, filed Dec. 10, 2013, the entire contents of which are incorporated herein by reference.

### FIELD

Embodiments described herein relate generally to an information processing system, an electronic apparatus, a method and a storage medium for scheduling medical consultations at a medical facility.

### BACKGROUND

In general, scheduling of medical consultations for patients at a medical facility is based on the order in which patients visit the medical facility, or the order of reservations. In this case, patients with severe symptoms to be preferentially examined may receive a low priority.

### BRIEF DESCRIPTION OF THE DRAWINGS

FIG. 1 shows an example of an outline configuration of an information processing system according to an embodiment.

FIG. 2 is a plan view showing an example of the back surface (surface attached firmly to a living body) of a biological sensor device according to the embodiment.

FIG. 3 is a block diagram showing an example of a circuit configuration of the biological sensor device according to the embodiment.

FIG. 4 is a block diagram showing a function configuration of an electronic apparatus according to the embodiment.

FIG. 5 is a figure for illustrating degrees of deviation calculated by the electronic apparatus according to the embodiment.

FIG. 6 is a flowchart showing a procedure of the processing executed by the electronic apparatus according to the embodiment.

FIG. 7 shows another configuration of the information processing system according to the embodiment.

FIG. 8 shows yet another configuration of the information processing system according to the embodiment.

FIG. 9 shows yet another configuration of the information processing system according to the embodiment.

### DETAILED DESCRIPTION

An embodiment will be hereinafter described with reference to the accompanying drawings.

In general, according to one embodiment, an information processing system includes a biological sensor device to be worn by a patient and an electronic apparatus. The biological sensor device includes a measurement processor to continuously measure biological information of the patient. The electronic apparatus includes a first acquisition processor, a generator, a calculator and a scheduler. The first acquisition processor acquires a biological information group including the continuously measured biological information from the biological sensor device. The generator performs time-series analysis on the biological information group and generates model information obtained by modeling a normal state of the patient wearing the biological sensor device. The calculator calculates a deviation indicating how much a manner of change of the biological information included in the biological information group deviates from a normal state of a patient indicated by the model information based on the biological information group and the model information. The scheduler schedules medical consultations for the patient based on a time when the patient visited a medical facility and the deviation.

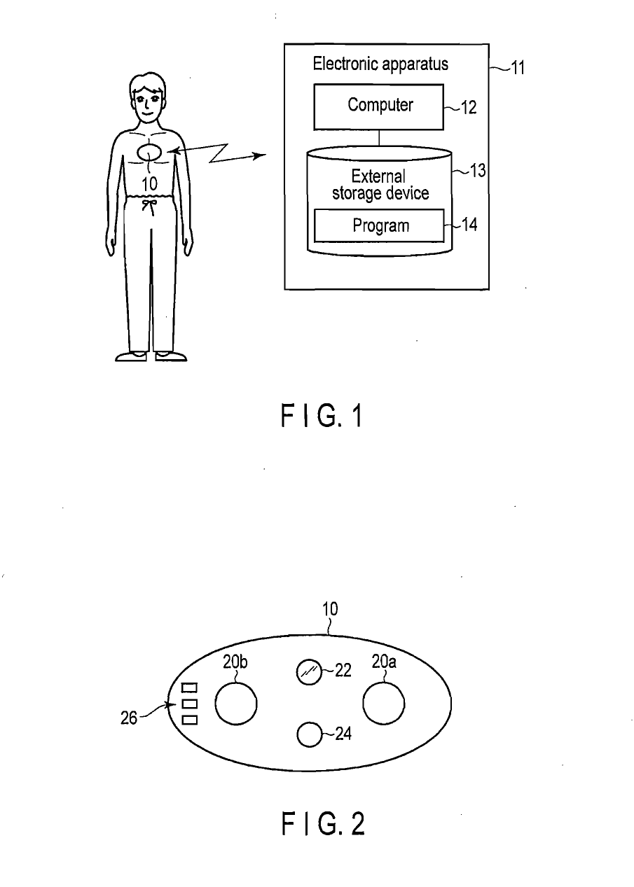

FIG. 1 is a block diagram showing an example of an outline configuration of an information processing system according to an embodiment. This information processing system is a system in which a biological sensor device 10 and an electronic apparatus 11 are communicatively connected to each other, as shown in FIG. 1. The biological sensor device 10 is small, light and thin, and driven by a battery (for example, embedded secondary battery). The biological sensor device 10 is affixed to the human body with, for example, adhesive tape to enable biological information to be always measured. It should be noted that regarding a method of attachment to the human body, the attachment may be carried out by a wristband or earphones as well as by affixing. The biological sensor device 10 has a function of simultaneously measuring and wirelessly sending out a plurality of biological information items such as a pulse wave, an electrocardiogram, body temperature and body motion to the electronic apparatus 11. It should be noted that before being sent out to the electronic apparatus 11, they can be temporarily stored in a flash memory 50 inside the biological sensor device 10. The biological sensor device 10 also has a function of wirelessly receiving a control signal, etc., from the electronic apparatus 11. It should be noted that when sending out the biological information items to the electronic apparatus 11, the biological sensor device 10 may send out identification information unique to the biological sensor device 10 to the electronic apparatus 11 together with them. Further, the biological sensor device 10 may send out only one biological information item of the plurality of measured biological information items to the electronic apparatus 11. Alternatively, only one biological information item may be measured.

As shown in FIG. 1, a computer 12 in the electronic apparatus 11 is connected to an external storage device 13 such as a hard disk drive (HDD). The external storage device 13 stores a program 14 executed by the computer 12. The computer 12 and the external storage device 13 form the electronic apparatus 11. The electronic apparatus 11 formed in this manner can be realized both by a hardware structure and by a combination structure of hardware resources and software. The program 14 which is preinstalled from a network or the external storage device 13 to the computer 12, and is for realizing each function of the electronic apparatus 11 is used as software of the combination structure.

First, the biological sensor device 10 (a measurement processor) will be described in detail.

Although the biological sensor device 10 includes a plurality of sensors such that a plurality of biological information items can be simultaneously measured, compatibility between flexibility and high performance is requested and the biological sensor device 10 sometimes increases in size, since analog front ends of the plurality of sensors have different specifications for each sensor. However, in this embodiment, a sensor module several millimeters square is realized by accumulating a plurality of analog front ends, a CPU, etc., on a single chip using pseudo-SoC technology. The pseudo-SoC technology is technology by which both downsizing as in an SoC and flexibility of design as in an SiP are realized by accumulating components on a wafer. The small, light (approximately ten and several grams) and thin (approximately several millimeters) biological sensor device 10 is realized by connecting a few peripheral components such as an antenna and a battery to this module. It should be noted that downsizing can also be realized by a structure using component built-in substrate technology or a dedicated LSI.

The biological sensor device 10 takes the form of, for example, an ellipse whose major axis is approximately several centimeters long, and an electrocardiogram electrode (R) 20a, an electrocardiogram electrode (L) 20b, a photoelectric unit 22, a temperature sensor 24 and a charging terminal 26 are located on a surface attached to the human body, as shown in FIG. 2. Since the electrocardiogram electrodes 20a and 20b need to be located on the right and left sides of a heart, they are located at intervals along the major axis. The photoelectric unit 22 is configured to optically detect a pulse wave, and a window portion made of a transparent material which passes light is provided on its front surface.

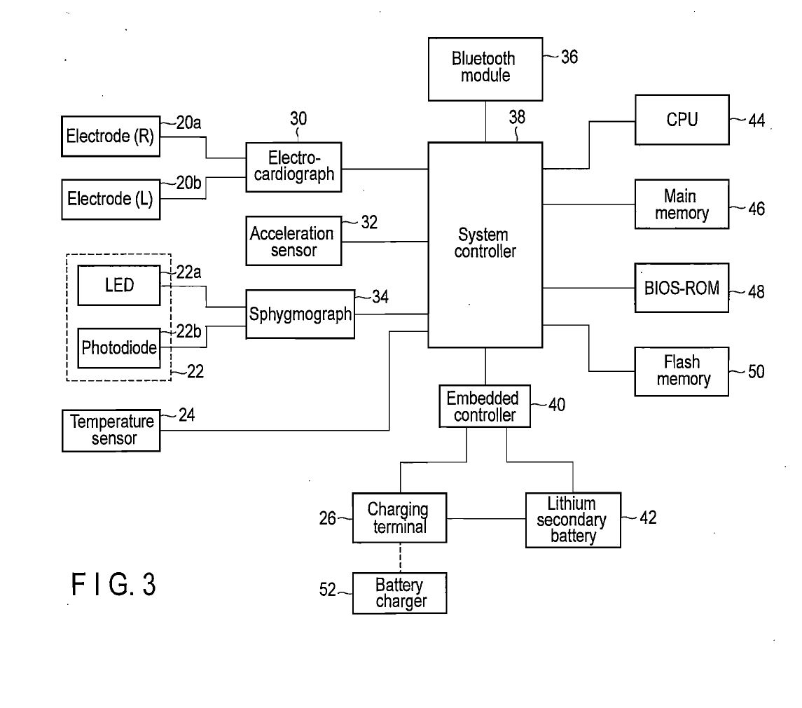

FIG. 3 is a block diagram illustrating a circuit configuration of the biological sensor device 10. The biological sensor device 10 includes not only the electrocardiogram electrodes 20a and 20b, the photoelectric unit 22, the temperature sensor 24 and the charging terminal 26 which are described above, but also an electrocardiograph 30, an acceleration sensor 32, a sphygmograph 34, a Bluetooth (registered trademark) module 36, a system controller 38, an embedded controller (EC) 40, a lithium secondary battery 42, a CPU 44, a main memory 46, a BIOS-ROM 48, the flash memory 50, etc.

The electrocardiogram electrode (R) 20a and the electrocardiogram electrode (L) 20b are connected to the electrocardiograph 30 which is an analog front end for an electrocardiogram. The electrocardiograph 30 obtains the electrocardiogram by analyzing a time-series signal obtained by sampling a potential difference between the electrocardiogram electrode (R) 20a and the electrocardiogram electrode (L) 20b. Furthermore, the electrocardiograph 30 determines a heart rate from the electrocardiogram, and determines an R-R Interval (RRI) which is an interval between two R waves corresponding to two consecutive heartbeats.

The photoelectric unit 22 is configured to sense a volume pulse wave, and includes a light-emitting element (for example, green LED) 22a which is a light source and a photodiode (PD) 22b which is a light receiving unit. A transparent window portion is provided on the front surface of the photoelectric unit 22, light from the green LED 22a is irradiated on the surface of the skin through the window portion, and reflected light is made incident on the PD 22b through the window portion. The green LED 22a and the PD 22b are connected to the sphygmograph 34 which is an analog front end for a pulse wave. The sphygmograph 34 senses change of the reflected light which changes in accordance with blood flow change in a blood capillary. The pulse wave is determined and the number of pulses is determined by analysis the sensed signal.

The electrocardiograph 30, the acceleration sensor 32, the sphygmograph 34 and the temperature sensor 24 are connected to the system controller 38. The temperature sensor 24 measures temperature at the body surface of the human body, and the acceleration sensor 32 measures body motion of the human body.

The CPU 44 is a processor configured to control an operation of each module and each component of the biological sensor device 10. As described above, the biological sensor device 10 can continuously measure various types of biological information (for example, body temperature, skin temperature, pulse count, heart rate, autonomic nervous activity index, blood pressure and sleeping time) by analyzing an output of each sensor, or a combination of outputs of a plurality of sensors.

It should be noted that the blood pressure is determined based on a pulse wave transit time (PWTT) based on a peak of an electrocardiographic waveform (peak of R wave) and a peak of the pulse wave. The pulse wave transit time refers to a time interval from appearance of an R wave of an electrocardiogram to appearance of a peripheral pulse wave. The pulse wave transit time is inversely proportional to a blood-pressure value. Thus, change of the blood pressure can be determined from the pulse wave transit time (PWTT). It should be noted that when the blood pressure is measured, an initial value indicating the relationship between the blood-pressure value and the pulse wave transit time may be predetermined. For example, a blood-pressure value of a user which is measured by a normal pressure measurement device and a pulse wave transit time at this time may be prestored in the flash memory 50 as an initial value. A current blood-pressure value of the user can be determined using change of a blood pressure determined from a current pulse wave transit time (PWTT) and this initial value (relationship between the blood-pressure value and the pulse wave transit time). Alternatively, instead of inputting the blood-pressure value of the user which is measured by the normal pressure measurement device and the pulse wave transit time at this time as the initial value, standard data indicating the relationship between the blood-pressure value and the pulse wave transit time may be prepared, and the current blood-pressure value of the user may be determined using this standard data and the change of the blood pressure determined from the current pulse wave transit time (PWTT). Further, the autonomic nervous activity index can be determined by analyzing a frequency of a time series of the above-described RRI. Further, the sleeping time can be determined by, for example, an equation called a Cole equation.

The system controller 38 is a bridge device configured to connect between the CPU 44 and each of modules and components. The Bluetooth module 36, the embedded controller (EC) 40, the CPU 44, the main memory 46, the BIOS-ROM 48 and the flash memory 50 are also connected to the system controller 38.

The embedded controller 40 is a power management controller for executing power management of the biological sensor device 10, and controls charge of an embedded secondary battery, for example, the lithium secondary battery 42. When the biological sensor device 10 is attached to a battery charger 52, a charging terminal 26 comes in contact with a terminal of the battery charger 52, charging current from the battery charger 52 is supplied to the biological sensor device 10 through the charging terminal 26, and the lithium secondary battery 42 is charged. The embedded controller 40 supplies an operation power source to each module and each component based on power from the lithium secondary battery 42.

Next, the electronic apparatus 11 will be described in detail.

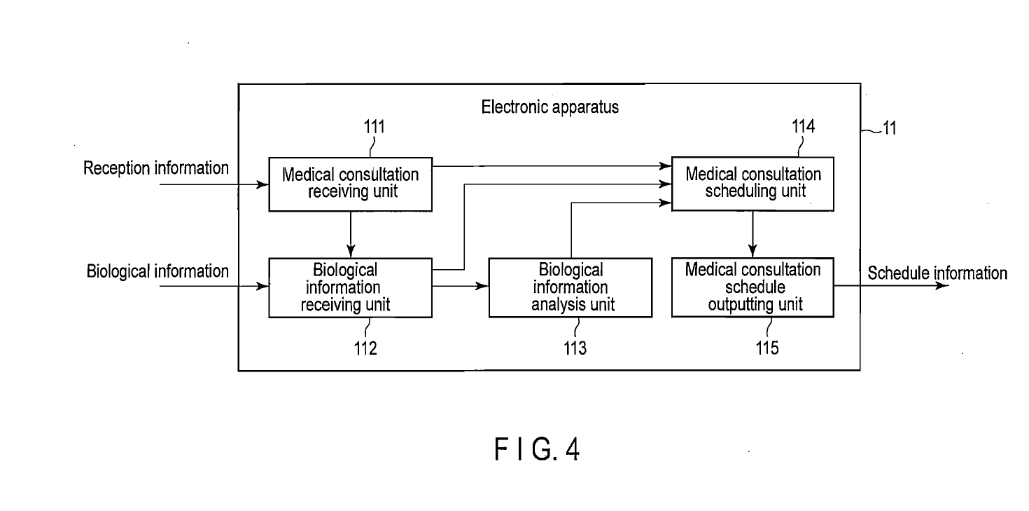

The electronic apparatus 11 includes a medical consultation receiving unit 111, a biological information receiving unit 112 (a first acquisition processor), a biological information analysis unit 113 (a generator), a medical consultation scheduling unit 114 (a calculator and a scheduler), a medical consultation schedule outputting unit 115, etc., as shown in FIG. 4. Functions of each of units 111 to 115 forming the electronic apparatus 11 will be hereinafter described.

The medical consultation receiving unit 111 accepts an input of reception information indicating that a patient has visited a medical facility (for example, a hospital or a clinic) (receives reception information). The reception information includes at least patient identification information which is identification information for identifying a patient, and time information indicating a time (reception time) when the patient visits a medical facility and checks in. The input reception information is sent to the biological information receiving unit 112 and the medical consultation scheduling unit 114. When the patient visits the medical facility (specifically, when the biological sensor device 10 confirms that the patient visits the medical facility by using the location information of the GPS, the beacon and the like), the biological sensor device 10 may be configured to transmit, to the electronic apparatus 11, the visit time or a time in which a predetermined time is added to the visit time. The transmitted time may be detected by a detector (not shown) in the electronic apparatus 11.

The reception information may be manually input by a doctor or a nurse from an input device not shown. Further, the reception information may be transmitted from a dedicated device not shown which can read an information storage medium (for example, medical consultation card) which is presented when a patient visits a medical facility and stores at least the patient identification information. It should be noted that the medical consultation receiving unit 111 itself may have a function similar to that of the above-described dedicated device. In this case, the medical consultation receiving unit 111 accepts an input of the reception information including the patient identification information stored in the information storage medium and the time information indicating a time (reception time) when reading processing is executed, by executing the reading processing on the information storage medium.

When accepting the input of the reception information sent from the medical consultation receiving unit 111, the biological information receiving unit 112 requests a patient to transmit the biological information (biological information group) stored in the biological sensor device 10. For example, the biological information receiving unit 112 requests a patient to transmit the biological information by causing a display device not shown to display a message prompting transmission of the biological information. The biological information receiving unit 112 accepts an input of the biological information group transmitted from the biological sensor device 10 in accordance with the above-described request (receives the biological information group). The input biological information group is sent to the biological information analysis unit 113. It should be noted that in the case where the biological information has not been transmitted even if a fixed period of time has passed after a patient is requested to transmit the biological information stored in the biological sensor device 10, the biological information receiving unit 112 recognizes that the patient does not wear the biological sensor device 10, and indicate this information to the medical consultation scheduling unit 114.

When accepting the input of the biological information group sent from the biological information receiving unit 112, the biological information analysis unit 113 performs time-series analysis on the input biological information group, and generates model information obtained by modeling a normal state of a patient. For example, an autoregressive model or a probability transition model (state transition model) is used as a specific method of the time-series analysis.

It should be noted that of a plurality of biological information items included in the input biological information group, the biological information analysis unit 113 uses the biological information in the normal state to generate the model information. The biological information in the normal state is biological information to which a tag indicating the normal state is added. The tag can be added to the biological information by causing a patient to input the normal state using, for example, an external device which can cooperate with the biological sensor device 10. Further, the tag may be added to the biological information by causing the patient to input the fact that he has not visited a medical facility using, for example, the external device.

Further, if a plurality of biological information items included in the input biological information group include a measured value related to a plurality of items, the biological information analysis unit 113 generates model information for each of the plurality of items. For example, if the input biological information is biological information including the measured value concerning body temperature and heart rate, the biological information analysis unit 113 generates model information concerning the body temperature and model information concerning the heart rate.

The autoregressive model is one of time-series analysis methods. If the autoregressive model is used as a time-series analysis method, the biological information analysis unit 113 predicts a value of the biological information (calculates a predicted value) using equation (1) below and models the normal state of the patient.

$$x ( t ) = {a}_{0} + {\sum }_{i = 1}^{N} {a}_{i} x ( t - i ) \qquad ( 1 )$$

That is, the biological information analysis unit 113 predicts a value of predetermined biological information in a predetermined time from a measured value included in the biological information before the predetermined time, and generates the model information obtained by modeling the normal state of the patient. The above t is a variable indicating a time (year, month, day, hour, minute and second). The above x(t) is a value for calculating the predicted value of the biological information at time t. The above i is a variable indicating any of 1 to N, and the above N is the number of biological information items used to generate the model information. The above a₀ is a constant term. The above aᵢ is a coefficient term, and is calculated using a known method such as a method of least squares or a Burg method. It should be noted that a process up to determination of constant term a₀ and coefficient term aᵢ is generally called modeling since a predicted value of the biological information can be appropriately determined once constant term a₀ and coefficient term aᵢ are determined; however, here, the process in which the predicted value of the biological information is calculated using equation (1), and change which can occur in the normal state is predicted using the calculated predicted value is called modeling.

The probability transition model is one of time-series analysis methods as well as the autoregressive model. If this probability transition model is used as a time-series analysis, the biological information analysis unit 113 calculates a probability of transition from state m to state n, and models a normal state of a patient. State m and state n are predefined, and indicate, for example, the state where the body temperature is high, the state where the body temperature is low, the state where the heart rate is high, and the state where the heart rate is low.

Specifically, the biological information analysis unit 113 counts the number of transitions from state m to state n based on a measured value included in two consecutive biological information items of a plurality of biological information items included in the input biological information group. Further, the biological information analysis unit 113 calculates the probability of transition from state m to state n based on the total number of state transitions and the number of transitions from state m to state n. In this case, a process up to calculation of the probability of transition from state m to state n is called modeling.

As described above, the biological information analysis unit 113 executes the processing of modeling the normal state of the patient, and generates the model information indicating the processing result.

When generating the model information, the biological information analysis unit 113 calculates a deviation indicating how much the latest (current) biological information item of the plurality of biological information items included in the input biological information group deviates from the normal state of the patient indicated by the model information. Analysis result information indicating the calculated deviation is sent to the medical consultation scheduling unit 114.

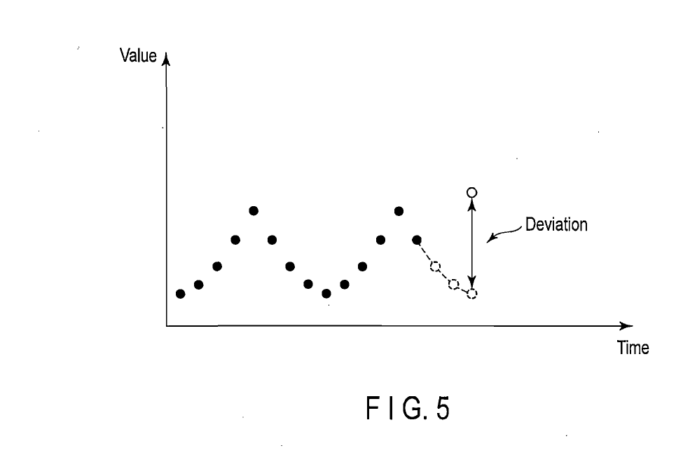

For example, if the model information is generated using the autoregressive model, the biological information analysis unit 113 calculates the deviation based on the difference between the measured value included in the latest biological information (white circle in FIG. 5) and a predicted value corresponding to the measured value indicated by the model information (dashed circle in FIG. 5), as shown in FIG. 5. Here, the deviation may be the difference itself between the measured value and the predicted value, or may be an arbitrary evaluation value which increases as the difference increases.

Further, if the model information is generated using the probability transition model, the biological information analysis unit 113 first recognizes to which state of a plurality of predefined states the latest biological information item of a plurality of biological information items included in the input biological information group corresponds (recognizes state n). Next, the biological information analysis unit 113 recognizes to which state of the plurality of predefined states the biological information including the measured value continuously measured immediately before the latest biological information item corresponds (recognizes state m). After that, the biological information analysis unit 113 determines whether the transition from state m to state n is a state transition of a high probability, that of medium probability, or that of a low probability with reference to the probability of transition from state m to state n indicated by the model information, and calculates the deviation. For example, if the transition from state m to state n is the state transition of the high probability as a result of the above-described determination, the biological information analysis unit 113 calculates, as a deviation, an arbitrary evaluation value which decreases as the probability of the state transition increases.

The medical consultation scheduling unit 114 accepts an input of reception information sent from the medical consultation receiving unit 111. Further, the medical consultation scheduling unit 114 accepts an input of indication, which is sent from the biological information receiving unit 112, that a patient does not wear the biological sensor device 10. Furthermore, the medical consultation scheduling unit 114 accepts an input of the analysis result information sent from the biological information analysis unit 113.

When accepting the inputs of various types of information, the medical consultation scheduling unit 114 determines a medical consultation schedule based on the time information included in the reception information, and the analysis result information. Specifically, the medical consultation scheduling unit 114 calculates the priority using equation (2) shown below, and determines the medical consultation schedule based on this priority.

Priority=α₁×f₁ (reception time)+α₂×f₂ (deviation) (2)

The above f₁ (reception time) indicates an arbitrary function whose value increases as the reception time indicated by the time information included in the input reception information is earlier. The above f₂ (deviation) indicates an arbitrary function whose value increases as the deviation indicated by the input analysis result information increases. However, if the indication, which is sent from the biological information receiving unit 112, that the patient does not wear the biological sensor device 10 is received, the above f₂ (deviation) becomes zero. The above α₁ and α₂ are coefficient terms. It should be noted that coefficient terms α₁ and α₂ are values which can be appropriately changed. For example, if a patient just started to wear the biological sensor device 10, the number of biological information items before a predetermined time (measured value for each item) is small, that is, a time series by the biological information is short. Thus, the normal state of the patient may not be correctly modeled by the biological information analysis unit 113, and the deviation may not be correctly calculated. Then, the medical consultation scheduling unit 114 can calculate also the priority of the patient who just started to wear the biological sensor device 10 with accuracy by making coefficient term α₂ smaller than usual. It should be noted that with respect to the patient who just started to wear the biological sensor device 10, the medical consultation scheduling unit 114 can calculate the priority of the patient who just started to wear the biological sensor device 10 with accuracy by causing the biological information analysis unit 113 to calculate the deviation based on the measured value included in the latest biological information and an average value of the biological information of a usual patient using the average value instead.

It should be noted that if the biological information input to the electronic apparatus 11 includes a measured value concerning a plurality of items, model information items are generated for each of the items, and a deviation is calculated based on each of the generated model information items, the medical consultation scheduling unit 114 can calculate the priority using equation (3) shown below. In equation (3), a case where the biological information includes a measured value concerning body temperature, heart rate and blood pressure is supposed.

Priority=α₁×f₁ (reception time)+α₂×f₂ (deviation of body temperature)+α₃×f₃ (deviation of heart rate)+α₄×f₄ (deviation of blood pressure) (3)

In equation (3), coefficient terms α₂ to α₄ may be set to be different for each diagnosis and treatment department. For example, in an internal medicine department, coefficient term α₂ may be made greater than coefficient terms α₃ and α₄ to give priority to a patient having a fever. Further, in a surgical department, coefficient terms α₃ and α₄ may be made greater than coefficient term α₂ to give priority to a patient losing much blood.

As shown above, the medical consultation scheduling unit 114 calculates the priority. It should be noted that equations (2) and (3) may further include variable αₙ obtained by quantifying the judgment of a doctor. In this case, the medical consultation scheduling unit 114 calculates new priority by further adding variable αₙ to the priority calculated using equations (2) and (3).

When calculating the priority, the medical consultation scheduling unit 114 determines a medical consultation schedule in accordance with the calculated priority. Here, the medical consultation scheduling unit 114 determines the medical consultation schedule to set the medical consultation schedule of a patient having a greater priority value to be earlier. Schedule information indicating the determined medical consultation schedule is sent to the medical consultation schedule outputting unit 115. It should be noted that the medical consultation schedule determined by the medical consultation scheduling unit 114 may be appropriately changed by a doctor or a nurse. In this case, the changed medical consultation schedule is a finally-determined medical consultation schedule, and this schedule information indicating the medical consultation schedule is sent to the medical consultation schedule outputting unit 115.

When accepting an input of the schedule information sent from the medical consultation scheduling unit 114, the medical consultation schedule outputting unit 115 outputs the input schedule information to a display device not shown, and displays the medical consultation schedule in the display device in a form which can be grasped by a doctor, a nurse or a patient. For example, the medical consultation schedule outputting unit 115 may display the medical consultation schedule in the display device not shown in a list form in which the patient identification information (or a name of a patient identified by the patient identification information) and the medical consultation schedule are associated with each other.

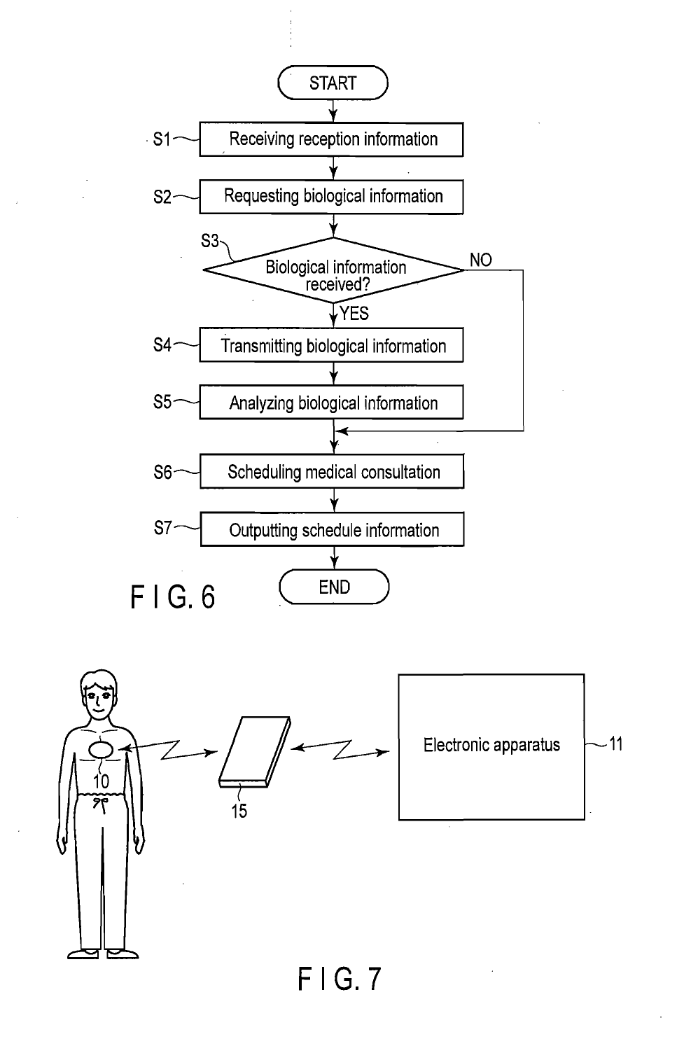

Next, a procedure of processing executed by the electronic apparatus 11 will be described with reference to the flowchart of FIG. 6.

First, the medical consultation receiving unit 111 receives reception information including the patient identification information and time information. The received reception information is transmitted to the biological information receiving unit 112 and the medical consultation scheduling unit 114 (step S1).

Subsequently, when receiving the reception information transmitted from the medical consultation receiving unit 111, the biological information receiving unit 112 displays a message prompting transmission of the biological information stored in the biological sensor device 10 in a display device not shown. That is, the biological information receiving unit 112 requests a patient to transmit the biological information (step S2).

Next, the biological information receiving unit 112 determines whether a biological information group transmitted from the biological sensor device 10 is received or not within a preset period of time (step S3). If the biological information group is not received within the preset period of time (NO in step S3), the biological information receiving unit 112 recognizes that a patient does not wear the biological sensor device 10, indicates this information to the medical consultation scheduling unit 114, and proceeds with step S6 to be described later.

If the biological information group is received within the preset period of time (YES in step S3), the biological information receiving unit 112 transmits the received biological information group to the biological information analysis unit 113 (step S4).

Subsequently, when receiving the biological information group transmitted from the biological information receiving unit 112, the biological information analysis unit 113 performs time-series analysis on the receive biological information group, and generates model information obtained by modeling a normal state of a patient. The biological information analysis unit 113 calculates a deviation indicating how much the latest biological information item of a plurality of biological information items included in the receive biological information deviates from the normal state of the patient indicated by the model information. Analysis result information indicating the calculated deviation is transmitted to the medical consultation scheduling unit 114 (step S5).

Next, when receiving the reception information transmitted from the medical consultation receiving unit 111, the indication transmitted from the biological information receiving unit 112 and the analysis result information transmitted from the biological information analysis unit 113, the medical consultation scheduling unit 114 calculates priority based on various types of received information, and determines the medical consultation schedule. The schedule information indicating the determined medical consultation schedule is transmitted to the medical consultation schedule outputting unit 115 (step S6).

After that, when receiving the schedule information transmitted from the medical consultation scheduling unit 114, the medical consultation schedule outputting unit 115 presents the determined medical consultation schedule to a patient by outputting and displaying the received schedule information to and in a display device not shown (step S7), and finishes the processing.

In this embodiment, an information processing system of a structure in which the biological sensor device 10 and the electronic apparatus 11 are communicatively connected to each other has been described; however, the structure of the information processing system is not limited to the above structure. For example, as shown in FIG. 7, the information processing system may includes the biological sensor device 10, the electronic apparatus 11 and a portable device 15, and may have a structure in which the biological sensor device 10 and the portable device 15 are communicatively connected to each other, and furthermore, the electronic apparatus 11 and the portable device 15 are communicatively connected to each other. The portable device 15 is, for example, a tablet computer, a notebook computer, a smartphone, a personal digital assistant (PDA), etc. In this case, the biological sensor device 10 transmits the biological information to the portable device 15 for each predetermined period of time using a short-range wireless communication function, etc., provided in both the biological sensor device 10 and the portable device 15 (i.e. the biological sensor device 10 includes a first transmitter). The biological information is stored in a memory, etc., in the portable device 15. When visiting a medical facility, a patient transmits the biological information to the electronic apparatus 11 using the portable device 15 (i.e. the electronic apparatus 11 includes a second acquisition processor). The electronic apparatus 11 executes various types of processing shown in the above-described FIG. 6, and transmits the schedule information indicating the determined medical consultation schedule to the portable device 15 (i.e. the electronic apparatus 11 includes a second transmitter). This enables the patient to confirm the determined medical consultation schedule on a screen of the portable device 15.

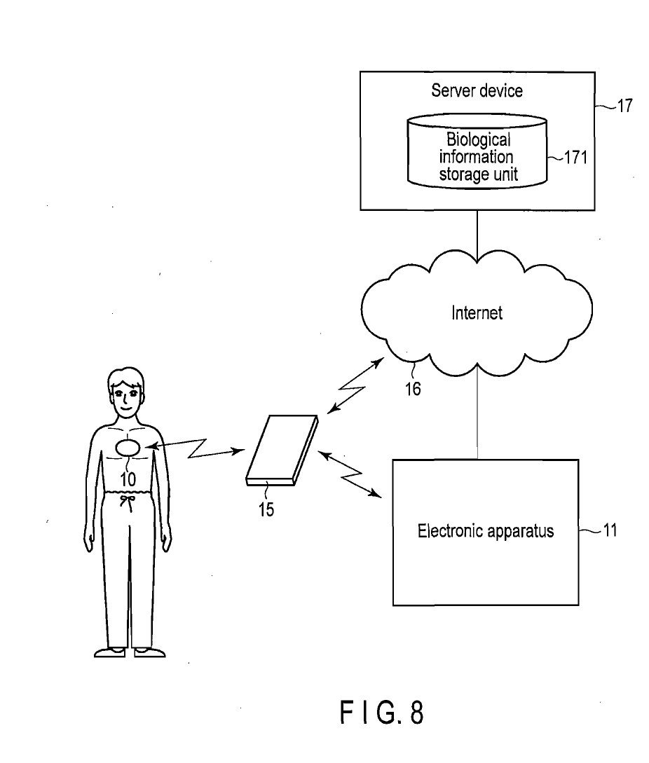

Further, as shown in FIG. 8, the information processing system may include the biological sensor device 10, the electronic apparatus 11, the portable device 15 and a server device 17, and may have a structure in which the biological sensor device 10 and the portable device 15 are communicatively connected to each other, and the electronic apparatus 11, the portable device 15 and the server device 17 are communicatively connected through the Internet.

In this case, the biological sensor device 10 transmits the biological information to the portable device 15 for each predetermined period of time using the short-range wireless communication function, etc., provided in both the biological sensor device 10 and the portable device 15 (i.e. the biological sensor device 10 includes a third transmitter). The portable device 15 transmits the biological information transmitted from the biological sensor device 10 to the server device 17 for each predetermined period of time along with the patient identification information. The server device 17 includes a biological information storage unit 171, and stores the biological information transmitted from the portable device 15 for each patient identification information item. When a patient visits a medical facility (that is, the reception information is received), the electronic apparatus 11 transmits the patient identification information included in the reception information to the server device 17, and requests to transmit the biological information corresponding to this patient identification information. When receiving the biological information transmitted from the server device 17, the electronic apparatus 11 executes various types of processing shown in the above-described FIG. 6, and transmits the schedule information indicating the determined medical consultation schedule to the portable device 15 (i.e. the electronic apparatus 11 includes a third acquisition processor and a forth transmitter). As shown above, managing the biological information in the server device 17 having greater storage capacity than a memory provided in the biological sensor device 10 or the portable device 15 allows analysis processing using more biological information items to be executed, whereby the medical consultation schedule can be accurately determined.

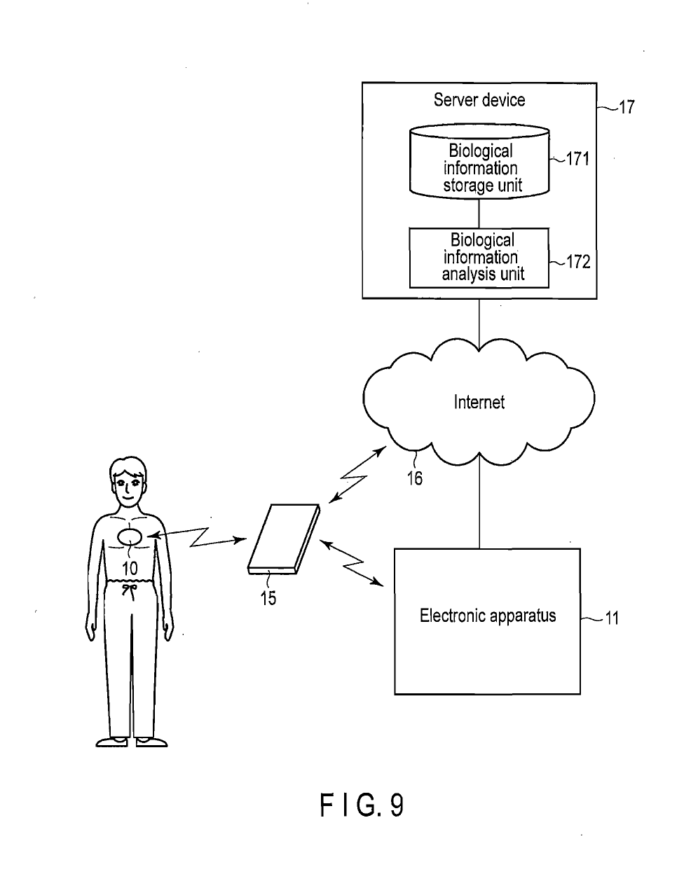

Furthermore, as shown in FIG. 9, a function corresponding to that of the biological information analysis unit 113 of the electronic apparatus 11 may be provided in the server device 17 in the information processing system. When the biological information is transmitted from the portable device 15 as described above, the server device 17 executes the processing corresponding to step S5 in the above-described FIG. 6 using a biological information analysis unit 172 having a function similar to that of the biological information analysis unit 113, and generates the analysis result information. The generated analysis result information is stored in the biological information storage unit 171. When a patient visits a medical facility (that is, the reception information is received), the electronic apparatus 11 transmits the patient identification information included in the reception information to the server device 17, and requests to transmit the analysis result information corresponding to the patient identification information. When receiving the analysis result information transmitted from the server device 17, the electronic apparatus 11 executes the processing of steps S6 and S7 shown in the above-described FIG. 6, and transmits the schedule information indicating the determined medical consultation schedule to the portable device 15. As described above, providing part of the function of the electronic apparatus 11 in the server device 17 allows the analysis processing to be pre-executed, whereby the schedule information can be transmitted earlier to the portable device 15.

According to the above-described embodiment, in the information processing system comprising the biological sensor device 10 and the electronic apparatus 11, the electronic apparatus 11 can model the normal state of the patient based on the biological information continuously measured by the biological sensor device 10, and determine the medical consultation schedule after determining how much the measured biological information deviates from the modeled normal state of the patient. That is, the medical consultation schedule can be suitably determined.

Although a method of determining a priority order based on a deviation from a predetermined fixed threshold value of the biological information of the patient has been proposed, a more accurate priority order can be determined in consideration of the normal state of an individual patient in this embodiment.

It should be noted that since the processing of this embodiment can be realized by a computer program, an advantage similar to that of this embodiment can be easily realized merely by installing this computer program in a computer and executing it through a computer-readable storage medium in which this computer program is stored.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a biological sensor device to be worn by a patient; and
an electronic apparatus,
wherein the biological sensor device includes a measurement processor to continuously measure biological information of the patient,
the electronic apparatus includes:
a first acquisition processor to acquire a biological information group including the biological information from the biological sensor device;
a generator to perform time-series analysis on the biological information group and to generate model information obtained by modeling a normal state of a patient wearing the biological sensor device;
a calculator to calculate a deviation indicating how much a manner of change of the biological information included in the biological information group deviates from a normal state of the patient indicated by the model information based on the biological information group and the model information; and
a scheduler to schedule medical consultations for the patient based on a time when the patient visited a medical facility and the deviation.

2. The system of claim 1,
wherein the measurement processor continuously measures at least one item of body temperature, skin temperature, number of pulses, heart rate, autonomic nervous activity index, blood pressure and sleeping time of the patient.

3. The system of claim 1,
wherein the generator performs time-series analysis on biological information to which tag information indicating a normal state is added, of the biological information included in the biological information group, using an autoregressive model or a probability transition model, and generates the model information.

4. The system of claim 1,
wherein the scheduler calculates priority based on a time when the patient visited a medical facility and the deviation, and schedules the medical consultations in accordance with the priority.

5. The system of claim 4,
wherein the scheduler reduces weighting for the deviation and calculates the priority if a number of biological information items included in the biological information group is smaller than a predetermined number.

6. The system of claim 4,
wherein the scheduler changes the weighting for the deviation for each diagnosis and treatment department which the patient visits, and calculates the priority.

7. The system of claim 1,
wherein the biological sensor device further includes a first transmitter to transmit the biological information group to an external device, and
the electronic apparatus further includes:
a second acquisition processor to acquire the biological information group from the external device; and
a second transmitter to transmit schedule information indicating the medical consultation schedule to the external device.

8. The system of claim 1,
wherein the biological sensor device further includes a third transmitter to transmit the biological information group to a server device through an external device,
the electronic apparatus further includes:
a third acquisition processor to acquire the biological information group from the server device; and
a fourth transmitter to transmit schedule information indicating the medical consultation schedule to the external device.

9. The system of claim 1,
wherein the electronic apparatus further includes a detector to detect a time when the patient visits the medical facility.

10. An electronic apparatus communicatively connected to a biological sensor device to be worn by a patient to continuously measure biological information of the patient, the electronic apparatus comprising:
a first acquisition processor to acquire a biological information group including the biological information from the biological sensor device;
a generator to perform time-series analysis on the biological information group, and to generate model information obtained by modeling a normal state of a patient wearing the biological sensor device;
a calculator to calculate a deviation indicating how much a manner of change of the biological information included in the biological information group deviates from a normal state of the patient indicated by the model information based on the biological information group and the model information; and
a scheduler to schedule medical consultations for the patient based on a time when the patient visited a medical facility and the deviation.

11. The electronic apparatus of claim 10,
wherein the generator performs time-series analysis on biological information to which tag information indicating a normal state is added, of the biological information included in the biological information group, using an autoregressive model or a probability transition model, and generates the model information.

12. The electronic apparatus of claim 10,
wherein the scheduler calculates priority based on a time when the patient visited a medical facility and the deviation, and schedules the medical consultations in accordance with the priority.

13. A method executed by an electronic apparatus communicatively connected to a biological sensor device to be worn by a patient to continuously measure biological information of the patient, the method comprising:
acquiring a biological information group including the biological information from the biological sensor device;
performing time-series analysis on the biological information group, and generating model information obtained by modeling a normal state of the patient wearing the biological sensor device;
calculating a deviation indicating how much a manner of change of the biological information included in the biological information group deviates from a normal state of a patient indicated by the model information based on the biological information group and the model information; and
scheduling medical consultations for the patient based on a time when the patient visited a medical facility and the deviation.

14. The method of claim 13,
wherein the generating includes performing time-series analysis on biological information to which tag information indicating a normal state is added, of the biological information included in the biological information group, using an autoregressive model or a probability transition model, and generating the model information.

15. The method of claim 13,
wherein the scheduling includes calculating priority based on a time when the patient visited the medical facility and the deviation, and scheduling the medical consultations in accordance with the priority.

16. A non-transitory computer-readable storage medium storing computer-executable instructions that, when executed, cause a computer to:
acquire a biological information group including a biological information of a patient from a biological sensor device;
perform time-series analysis on the biological information group, and generate model information obtained by modeling a normal state of a patient wearing the biological sensor device;
calculate a deviation indicating how much a manner of change of the biological information included in the biological information group deviates from a normal state of the patient indicated by the model information based on the biological information group and the model information; and
schedule medical consultations for the patient based on a time when the patient visited a medical facility and the deviation.

17. The storage medium of claim 16,
wherein the computer is caused to perform time-series analysis on biological information to which tag information indicating a normal state is added, of the biological information included in the biological information group, using an autoregressive model or a probability transition model, and to generate the model information.

18. The storage medium of claim 16,
wherein the computer is caused to calculate priority based on a time when the patient visited a medical facility and the deviation, and to schedule the medical consultations in accordance with the priority.
